(19) United States
(12) Patent Application Publication
(10) Pub. No.: US 2014/0143766 A1
(43) Pub. Date: May 22, 2014

(54) METHOD FOR RE-SKINNING A THIRD PARTY'S APPLICATION

(71) Applicants: Weixing Li, Beijing (CN); Peng Sun, Beijing (CN); Xinyu Liu, Beijing (CN); Yahui Wang, Beijing (CN); Hongguang Dong, Beijing (CN); Tian Ren, Beijing (CN); Fei Xu, Beijing (CN); Bin Zhang, Beijing (CN); Feng Liang, Beijing (CN); Wanqiang Li, Beijing (CN); Jiangji Huang, Beijing (CN)

(72) Inventors: Weixing Li, Beijing (CN); Peng Sun, Beijing (CN); Xinyu Liu, Beijing (CN); Yahui Wang, Beijing (CN); Hongguang Dong, Beijing (CN); Tian Ren, Beijing (CN); Fei Xu, Beijing (CN); Bin Zhang, Beijing (CN); Feng Liang, Beijing (CN); Wanqiang Li, Beijing (CN); Jiangji Huang, Beijing (CN)

(73) Assignee: Xiaomi Inc., Beijing (CN)

(21) Appl. No.: 14/129,769

(22) PCT Filed: Mar. 19, 2012
(86) PCT No.: PCT/CN2012/072549

§ 371 Date: Jan. 20, 2014

(30) Foreign Application Priority Data
Jun. 30, 2011 (CN) 201110181919.1

(51) Int. Cl. G06F 9/445

(52) U.S. Cl. CPC G06F 8/65
USPC 717/169

(57) ABSTRACT

Disclosed is a method for re-skinning a third party's application. A third-party application establishes a resource file package. The resource file package includes a resource file storage path and a mapping relation between them. A subject file package is established which shares the resource file storage path. The subject file package includes resource files for presentation to be replaced. To generate a re-skinning presentation the third-party application sends the resource ID for a resource file to be presented to an operating system; the operating system obtains a corresponding resource file storage path from the resource file package according to the resource file ID; and the operating system obtains the resource file to be replaced for presentation from the subject file packet according to the resource file storage path. The resource file to be replaced for presentation is sent to the third-party application and presented to generate the re-skinning presentation.

### FIELD OF ART

The present disclosure relates to the field of mobile terminal technology, and more particularly to a method for re-skinning a third party's application.

### BACKGROUND

With the development of mobile device technology, the mobile device has become an indispensable personal electronic device in people's everyday life, whereby people can gain access to information, conduct their office work and be entertained. Since the types and models of mobile devices are small in relation to the size of user groups, users have to constantly change the presentation effect of various applications on the mobile device to showcase their personality.

Some efforts have been made for re-skinning of existing applications in which some resource files are arranged in resource file packages when the applications are developed by program developers. Thereafter, when users employ the applications, the desired presentation effect can be selected from the different resource files. However, only limited preset resource files are available to the user for re-skinning Therefore, there are limited options for the users. Further updating options are not available.

### SUMMARY

The purpose of the present disclosure is to provide a method for re-skinning a third party's application which can provide unlimited resource files and improve the presentation effect of various applications.

To this end, the present disclosure adopts the following technical scheme:

A method for re-skinning a third party's application, suitable for an android system, comprising the following steps:
A. establishing a resource file package of the third party's application, the resource file package includes a resource file ID, a resource file storage path and a mapping relation between them;
B. establishing a subject file package, the subject file package includes resource files of the third party's application to be replaced for presentation which share the resource file storage path of the resource file package;
C. sending by the third party's application the resource file ID for a re-skinning presentation to an operating system;
D. the operating system obtaining a respective resource file storage path from the resource file package according to the resource file ID;
E. the operating system obtaining the resource files of the third party's application to be replaced for presentation from the subject file package according to the resource file storage path;
F. the operating system sending the resource files of the third party's application to be replaced for presentation to the third party's application; and
G. presenting at the third party's application the resource files of the third party's application to be replaced for generating the re-skinning presentation.

The resource file package of the third party's application includes resource files of the third party's application for presentation. If the operating system does not find the resource files of the third party's application to be replaced for presentation in the subject file package, the resource files for presentation are obtained from the resource file package.

With the technical scheme in the present disclosure, any individuals, including users, can add resource files into the third party's application. Accordingly, the presentation effect of the third party's application can be constantly updated.

### BRIEF DESCRIPTION OF THE FIGURE

FIG. 1 is a flowchart illustrating a method for re-skinning a third party's application according to an exemplary embodiment.

### DETAILED DESCRIPTION OF EMBODIMENTS

Embodiments of the present disclosure are further described in detail with reference to the accompanying FIGURE.

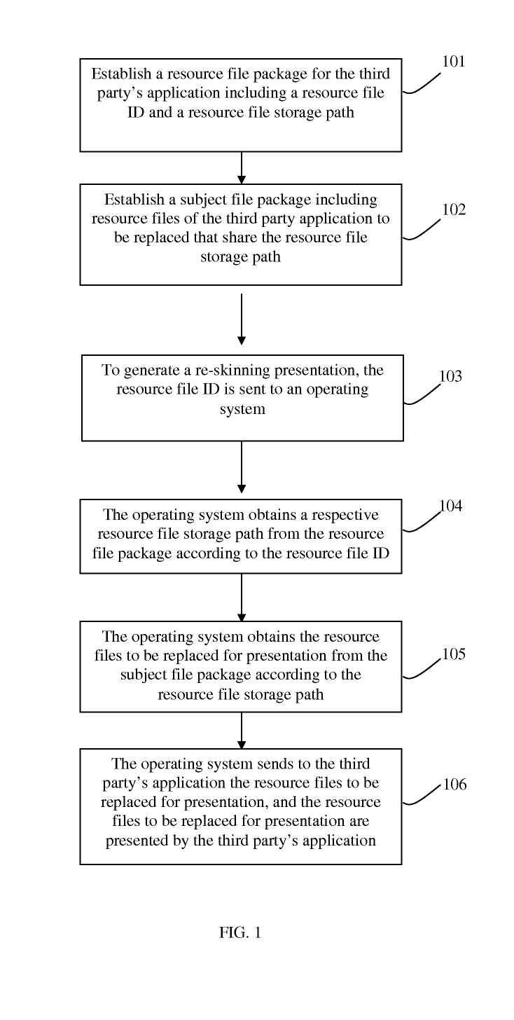

FIG. 1 is a flowchart illustrating a method for re-skinning a third party's application according to an exemplary embodiment. As shown in FIG. 1, the process of re-skinning a third party's application comprises the following steps:

Step 101. A resource file package for an application, such as a third party's application is established. The resource file package includes resource files of the third party's application for presentation, and includes a resource file ID, a resource file storage path and a mapping relation between them.

Step 102. A subject file package is established according to a directory structure in the resource file package of the third party's application. The subject file package includes resource files of the third party's application to be replaced for presentation. The resource files of the third party's application to be replaced for presentation share the same resource file storage path with the resource files of the resource file package.

Step 103. To generate a re-skinning presentation, the resource file ID for the re-skinning presentation is sent by the third party's application to an operating system.

Step 104. The operating system obtains a respective resource file storage path from the resource file package according to the resource file ID.

Step 105. The operating system obtains the resource files of the third party application to be replaced for presentation from the subject file package according to the resource file storage path.

If there are resource files to be replaced for presentation according to the corresponding resource storage path of the subject file package, the operating system obtains the resource files to be replaced for presentation.

If the operating system does not find resource files of the third party's application to be replaced for presentation from the corresponding resource file storage path of the subject file package, the resource files for presentation are obtained from the resource file package of the third party's application.

Step 106. The operating system sends the resource files of the third party's application to be replaced for presentation to the third party's application. The resource files of the third party's application to be replaced are presented by the third party's application for generating a re-skinning for presentation.

If the operating system does not find the resource files of the third party's application to be replaced for presentation from the corresponding storage path of the subject file package, the resource files for presentation of the resource file package are sent to the third party's application, and the resource files from the resource file package are presented by the third party's application.

The above is a detailed description of the technical features of the present disclosure based on a preferred embodiment. However, it should be appreciated that the present disclosure is capable of a variety of embodiments and various modifications by those skilled in the art, and all such variations or changes shall be embraced within the scope of the following claims.

1. A method for re-skinning a third party's application, comprising the following steps:
establishing a resource file package of the third party's application, the resource file package includes a resource file ID, a resource file storage path and a mapping relation between them;
establishing a subject file package, the subject file package includes resource files of the third party's application to be replaced for presentation which share the resource file storage path of the resource file package;
sending by the third party's application the resource file ID for a re-skinning presentation to an operating system;
the operating system obtaining a respective resource file storage path from the resource file package according to the resource file ID;
the operating system obtaining the resource files of the third party's application to be replaced for presentation from the subject file package according to the resource file storage path;
the operating system sending the resource files of the third party's application to be replaced for presentation to the third party's application; and
presenting at the third party's application the resource files of the third party's application to be replaced for generating the re-skinning presentation.

2. The method defined in claim 1, wherein the resource file package of the third party's application includes resource files of the third party's application for presentation, if the resource files of the third party's application to be replaced for presentation are not found by the operating system in the subject file package, further comprising the step of obtaining the resource files for presentation from the resource file package.

3. A method for re-skinning an application, comprising the following steps:
establishing a resource file package of the application, the resource file package includes a resource file ID, a resource file storage path and a mapping relation between them;
establishing a subject file package, the subject file package includes resource files of the application to be replaced for presentation which share the resource file storage path of the resource file package;
generating a re-skinning presentation by obtaining resources files of the application to be replaced from the subject file package according to the resource file ID and resource file storage path for the re-skinning presentation and presenting the resource files of the application to be replaced.

4. The method defined in claim 3, wherein the resource file package of the application includes resource files of the application for presentation, if the resource files of the application to be replaced for presentation are not found by the operating system in the subject file package, further comprising the step of obtaining the resource files for presentation from the resource file package.

5. A non-transitory computer-readable storage medium storing executable computer program instructions for re-skinning an application, the computer program instructions comprising instructions for:
establishing a resource file package of the application, the resource file package includes a resource file ID, a resource file storage path and a mapping relation between them;
establishing a subject file package, the subject file package includes resource files of the application to be replaced for presentation which share the resource file storage path of the resource file package;
generating a re-skinning presentation by obtaining resources files of the application to be replaced from the subject file package according to the resource file ID and resource file storage path for the re-skinning presentation and presenting the resource files of the application to be replaced.

6. The non-transitory computer readable storage medium of claim 5, wherein the resource file package of the application includes resource files of the application for presentation, and if the resource files of the application to be replaced for presentation are not found by the operating system in the subject file package, the computer program providing instructions for obtaining the resource files for presentation from the resource file package.
